(19) United States
(12) Patent Application Publication
(10) Pub. No.: US 2014/0071723 A1
(43) Pub. Date: Mar. 13, 2014

(54) USING POWER FACTOR CONTROL TO OPTIMIZE POWER GENERATION AND ALLOCATION

(71) Applicant: Robert S. Wrathall, Scotts Valley, CA (US)

(72) Inventor: Robert S. Wrathall, Scotts Valley, CA (US)

(21) Appl. No.: 14/026,262

(22) Filed: Sep. 13, 2013

Related U.S. Application Data
(60) Provisional application No. 61/700,719, filed on Sep. 13, 2012.

(51) Int. Cl. H02M 1/42

(52) U.S. Cl. CPC H02M 1/4208
USPC 363/84; 323/205

(57) ABSTRACT

The disclosed technology performs power factor correction involving rectifying and adjusting an input power supply signal with a PWM signal. The PWM signal is generated based on a closed feedback signal obtained from a load, as well as adjusted harmonic content retrieved from a sensed input power supply signal. The adjusted harmonic content is produced by extracting a fundamental signal and a plurality of harmonic signals from the sensed input power supply signal, modifying the plurality of harmonic signals by dividing by the fundamental signal, and combining the modified harmonic signals into a duty factor distortion signal. The duty factor distortion signal controls a duty factor of the PWM signal to provide a substantially square wave template. Furthermore, the power factor is increased by forcing the input power supply signal to follow the substantially square wave template.

### CROSS-REFERENCE TO RELATED APPLICATION

This application claims benefit of U.S. Provisional Patent Application Ser. No. 61/700,719 filed on Sep. 13, 2012, which is incorporated herein by reference in its entirety for all purposes.

### TECHNICAL FIELD

This disclosure relates generally to supplying electrical power to a load and, more particularly, to power factor correction.

### DESCRIPTION OF RELATED ART

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

Typically, standards for supplying electrical power ensure power is supplied in a manner that does not disrupt the operation of an alternating current (AC) power grid or any electrical devices connected thereto. For example, the power supply standards presently set for the phase relationship of voltage and current require that the electrical power is supplied by electrical supply devices at a nearly united power factor. The power factor is traditionally defined as the ratio of real power absorbed by a load and apparent power applied to the load from a power source. Thus, power supplying systems providing electrical power to the power grid or load may include various power factor correction (PFC) circuits to ensure the phase relationship falls within predetermined limits. The PFC circuits may be implemented in various digital and/or analog designs, however conventional PFC circuits are still unable to provide a power factor that would minimize losses in the power grid and associated devices.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is directed to performing power factor corrections on an input power supply signal involving rectifying and adjusting the input power supply based on a PWM signal. The PWM signal may be generated based upon a closed feedback signal obtained from a load, as well as adjusted harmonic content retrieved from a sensed input power supply signal. The present technology may provide for extracting a fundamental signal and a plurality of harmonic signals from the sensed input power supply signal, modifying the plurality of harmonic signals by dividing the fundamental signal therefrom, and combining the modified harmonic signals into a duty factor distortion signal. The duty factor distortion signal controls a duty factor of the PWM signal and may provide a substantially square wave template. Furthermore, forcing the input power supply signal to follow the substantially square wave template causes the power factor to increase. The increased power factor may enable increasing power output up to 110% of initial capacity of power generators.

According to an aspect of the present disclosure, provided is a method for performing a power factor correction on an input power supply signal. The method may include performing, by a Fourier transformation unit, a Fourier transformation of a current sense signal associated with the input power supply signal to produce a fundamental signal of the current sense signal and a plurality of harmonic signals associated with the current sense signal. The method may further include adjusting each of the harmonic signals based at least in part on a plurality of wave shaping coefficients to generate a plurality of difference signals. The method may further include producing, by an inverse Fourier transformation unit, a duty factor distortion signal based at least in part on the difference signals. The method may further include controlling a duty factor of a PWM signal based at least in part on the duty factor distortion signal. The method may further include modifying the input power supply signal using at least the PWM signal.

In certain embodiments, the plurality of wave shaping coefficients is based on the fundamental signal and multiple harmonic ratio values. Each of the wave shaping coefficients may include the fundamental signal multiplied by a harmonic ratio value. Each of the wave shaping coefficients may be associated with a corresponding harmonic ratio value. The adjusting of each of the harmonic signals may include extracting from each of the harmonic signals the wave shaping coefficients. The producing of the duty factor distortion signal may include performing inverse Fourier transformation under the plurality of difference signals and multiplying a signal resulted from the inverse Fourier transformation onto a gain signal. The PWM signal may be produced based on both the duty factor distortion signal and a current feedback signal.

In certain embodiments, the method may further include rectifying an AC power supply signal to produce the input power supply signal. The method may further include transforming the input power supply signal into an output power supply signal. The output power supply signal may include an AC output signal. The output power supply signal may include a direct current (DC) output signal. The method may further include storing the plurality of difference signals in a memory in association with a current state of a load. The modifying of the input power supply signal using at least the PWM signal may include producing a substantially square signal. The method may further include embodying a closed loop scheme to produce a current feedback signal. Peaks of the input power supply signal may be reduced, according to some embodiments. The method may further include measuring the current sense signal of the input power supply signal.

According to another aspect of the present disclosure, provided is a circuit for performing power factor correction on an input power supply signal. The circuit may include an AC-DC inverter. The circuit may include a sensing unit configured to produce a current sense signal associated with the input power supply signal. The circuit may further include a Fourier transformation unit configured to perform Fourier transformation under the current sense signal to produce a fundamental signal of the current sense signal and a plurality of harmonic signals associated with the current sense signal. The circuit may further include a power factor correction unit configured to adjust each of the harmonic signals based at least in part on predetermined criteria. The circuit may further include an inverse Fourier transformation unit configured to produce a duty factor distortion signal based at least in part on the harmonic signals. The circuit may further include a PWM unit configured to control a duty factor of a PWM signal based at least in part on the duty factor distortion signal and to modify the input power supply signal using at least the PWM signal. The power factor correction unit may be further configured to produce plurality of difference signals by adjusting each of the harmonic signals. In certain embodiments, the adjusting of each of the harmonic signals may include extracting, from each of the harmonic signals, wave shaping coefficients. Each of the wave shaping coefficients may include the fundamental signal multiplied by a harmonic ratio value, and each of the wave shaping coefficients may be associated with a corresponding harmonic ratio value. The circuit may further include a rectifying circuit configured to rectify an AC power supply signal to produce the input power supply signal.

According to yet another aspect of the present disclosure, provided is a method for performing power factor correction on an input power supply signal. The method may include rectifying an AC power supply signal to produce the input power supply signal, sensing a current sense signal associated with the input power supply signal, retrieving a plurality of harmonic signals of the current sense signal, producing a plurality of adjusted harmonic signals based at least in part on predetermined criteria, generating a duty factor distortion signal based at least in part on a combination of the plurality of adjusted harmonic signals, controlling a duty factor of a PWM signal based at least in part on the duty factor distortion signal to generate a substantially square wave of the PWM signal, and modifying the input power supply signal using at least the PWM signal.

In further example embodiments of the present disclosure, the method steps are stored on a non-transitory machine-readable medium comprising instructions, which when implemented by one or more processors or controllers perform the recited steps. In yet further example embodiments, hardware systems or devices can be adapted to perform the recited steps. Other features, examples, and embodiments are described below.

### BRIEF DESCRIPTION OF THE DRAWINGS

Embodiments are illustrated by way of example, and not by limitation, in the figures of the accompanying drawings, in which like references indicate similar elements and in which:

FIG. 1 is a graph illustrating voltage and resistive and reactive current as functions of time, according to an example embodiment.

FIG. 2 is a graph illustrating the time value of power in reactive and resistive loads, according to an example embodiment.

FIG. 3 is a graph illustrating energy in resistive and reactive loads as a function of time, according to an example embodiment.

FIG. 4 is a graph illustrating core saturation as a function of current, according to an example embodiment.

FIG. 5 is a graph illustrating an example of non-linear load current as a function of time, according to an example embodiment.

FIG. 6 is a graph illustrating energy in a resistive and non-linear load as a function of time, according to an example embodiment.

FIG. 7 is a graph illustrating square current compared to resistive load as a function of time, according to an example embodiment.

FIG. 8 is a graph illustrating power curves and comparing power to a square current load, according to an example embodiment.

FIG. 9 is a graph illustrating energy deposited into a load and comparing a resistive load with a square current load, according to an example embodiment.

FIG. 10 is a simplified block diagram illustrating an AC-DC inverter involving a PFC control circuit, according to an example embodiment.

FIG. 11 is a simplified block diagram illustrating an AC-DC inverter involving a super PFC (SPFC) control circuit, according to an example embodiment.

FIG. 12 is a graph illustrating Fourier construction of a square like wave using the fundamental and three odd harmonics, according to an example embodiment.

FIG. 13 is a graph illustrating the energy generated in one cycle of a generator and comparing a resistive load to a perfect square load and to an approximate square load with three harmonics, according to an example embodiment.

FIG. 14 is a high level diagram of SPFC circuit, according to an example embodiment.

FIG. 15 is a high level diagram of a method for performing PFC, according to an example embodiment.

FIG. 16 is block diagram of exemplary system for practicing embodiments according to the present disclosure, according to an example embodiment.

### DETAILED DESCRIPTION

Before explaining the presently disclosed and claimed inventive concept(s) in detail by way of example embodiments, drawings, and appended claims, it is to be understood that the present disclosure is not limited in its application to the details of construction and the arrangement of the components set forth in the following description or illustrated in the drawings. The present disclosure is capable of other embodiments or of being practiced or carried out in various ways. As such, the language used herein is intended to be given the broadest possible scope and meaning; and the embodiments are meant to be exemplary and not exhaustive. It is to be understood that the phraseology and terminology employed herein is for the purpose of description and should not be regarded as limiting. Unless otherwise required by context, singular terms may include pluralities and plural terms may include the singular.

The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The embodiments disclosed herein may be implemented using a variety of technologies. For example, the methods described herein may be implemented in software executing on a computer system or in hardware utilizing either a combination of microprocessors or other specially designed application-specific integrated circuits (ASICs), programmable logic devices, or various combinations thereof. In particular, the methods described herein may be implemented by a series of computer-executable instructions residing on a non-transitory storage medium such as a disk drive, or non-transitory computer-readable medium. It should be noted that methods disclosed herein can be implemented by a computer (e.g., a desktop computer, tablet computer, laptop computer), game console, handheld gaming device, cellular phone, smart phone, smart television system, and so forth.

A power factor describes the ratio of “real” power to “total” power. For example, the heat which emanates from an electric stove or a radiant space heater is created by electricity which comes through power lines from a generator. The generator can be powered by energy sources like wind, water, coal, oil, hydroelectric, geothermal, biofuel, or nuclear chain reaction, etc. The energy sources may also include a solar array with a conventional mechanical power generator replaced by photovoltaic elements to transform sunlight into electricity. Other suitable energy source can be used as well.

There are three main types of circuit elements which can serve as loads for a generator. The first type is a resistor. A resistor can transform energy of electrical current into thermal energy, for example, in the electric stove or radiant space heater mentioned above. In a well-tuned electrical system, the energy can be transmitted to the resistor very efficiently. The generator has a relatively small resistance, much smaller than the load, so that the same current which causes the space heater to glow will cause the generator to warm a little.

There are transformers in a standard power grid which can have a resistive load. These transformers transform the voltage from the generator to the voltage that the space heater, for example, can use. Again, the resistance of the transformer is much less than that of the radiant heater, in this example, therefore, the transformer can become warm when the space heater is hot.

These resistances are known as “parasitic,” since they waste energy by converting it into heat. The parasitic losses reduce the efficiency of the system. The following equation can quantify the efficiency as a ratio of the useful energy (the heat produced by the radiant heater, for example) to the total energy which includes the parasitic losses:

Efficiency=Power used/(Power used+Parasitic power) (1)

If this ratio is small, then the parasitic losses are high. There is a different kind of loads of which there is not normally awareness. These loads do not consume energy and do not get hot. A physical analogy can include applying force to elastic objects. For example, as a spring compresses, it stores mechanical energy and produces some heat. Spring resistance is similar to the resistance of the radiant heater—the faster the spring is compressed the more heat is produced.

Two types of electrical elements for storing energy include a capacitor and an inductor. The capacitor stores energy in the form of a static electric field of the device. The inductor stores energy in the form of a magnetic field. Some capacitors and inductors can have very little resistance, thus most of the energy which goes into these devices is stored and little is converted to heat. If a capacitor or inductor is coupled to a generator, the energy generated by the generator is stored in the capacitor or inductor. That energy can be extracted at a later time. Notably, the power storage and extraction processes are essentially lossless. Thus, capacitors and inductors can be connected to generators and there will be no heat generated except for some heat lost due to the parasitic resistances of the generator, i.e., associated with the transformers and the wires which connect the inductors and capacitors to the generator. The power stored by these lossless elements is called “reactive” power because the energy stored can react again, unlike a resistor element where the power is lost to the environment.

The power factor may be calculated as if the reactive power were real power. But first, the relationship between energy and power should be introduced. Power is the rate at which energy is produced. Power is the instantaneous product of the voltage across a load times of the current through the load, which can be represented by the following equation:

Power(t)=V(t)*I(t) (2)

Power can be both positive and negative depending on whether power is flowing into or out of the load. The relationship between energy and power should be considered. Power is the measure of how fast energy is expended. A good example is a photoflash. The power of photoflash may be a million watts (a power unit). The total energy in the flash might be just one joule (an energy unit), enough to barely warm one's hands because the flash only lasts a millionth of a second.

Average power should be considered as well. If one only uses the flash once a day, its average power is 1 joule divided by 86400 seconds, or 0.0000157 watts. In this context, the reactive loads have an average power loss of substantially zero because the power is removed losslessly. A typical time used for averaging in a power system is the time of one cycle of the generator.

Average power may be calculated using the following equation:

Pₐᵥ=∫₀^{Tcyle}V(t)*I(t)dt/Tcycle (3)

where V is voltage, I is current, t is time variable, and T cycle is a time of generator cycle. The integral is the sum of all the instantaneous powers over the course of one cycle. The average is computed as the sum of these instantaneous powers divided by the time for one cycle. For a resistive load, the instantaneous powers over the cycle are positive so they add up to a positive number. However, a reactive load has as much negative as positive power so that the sum of the instantaneous powers adds up to zero over a cycle of AC current.

Another way of measuring power is the root mean square (RMS) power. The average of the square of power is similar to the average power except that the instantaneous power is the square of the power. The RMS stands for the square root of the average of the square of the power as outlined below:

$$\begin{matrix}Prms = Vrms * Irms \\ where & ( 4 ) \\ Vrms = {\{ \frac{{\int }_{0}^{Tcycle} {V ( t )}^{2} d t}{Tcycle} \}}^{1 / 2} \\ and & ( 5 ) \\ Irms = {\{ \frac{{\int }_{0}^{Tcycle} {K ( r )}^{2} d t}{Tcycle} \}}^{1 / 2} & ( 6 )\end{matrix}$$

For resistive loads, Pav=Prms, but for reactive loads, Pav=0 while the Prms>0. For the reactive load, because energy is stored in the reactive component, energy flows in through a part of the cycle and out during the other part without being converted to heat, which would be a loss.

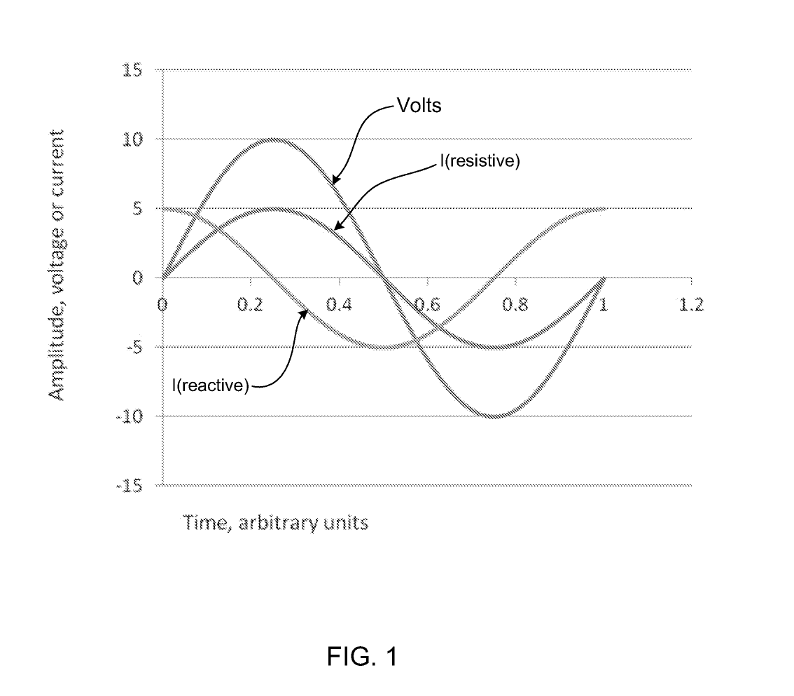

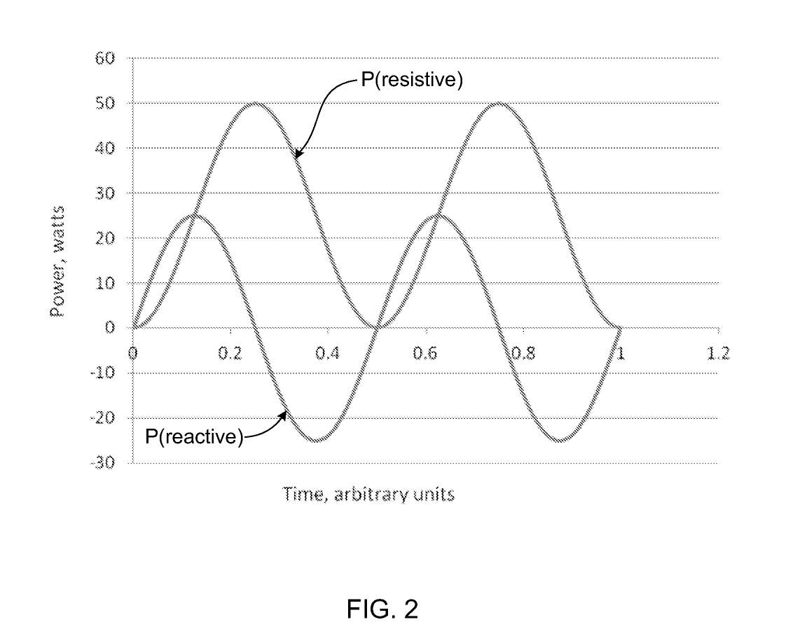

In this example, voltage and current are functions of time and the units are arbitrary. The resistive current may follow the voltage whereas the inductive current may lead the current, which is the case for magnetic storage elements or inductors. This principle is illustrated in FIG. 1 which shows an amplitude-time relationship of voltage and currents flowing through a resistive element and a reactive (e.g., inductive) element. As shown in FIG. 1, the offset in the inductive (reactive) current is significant because it signifies energy storage in the load. FIG. 2 further illustrates this in showing power in a resistive load being positive, whereas the power in a reactive load alternates between positive and negative over a period of time.

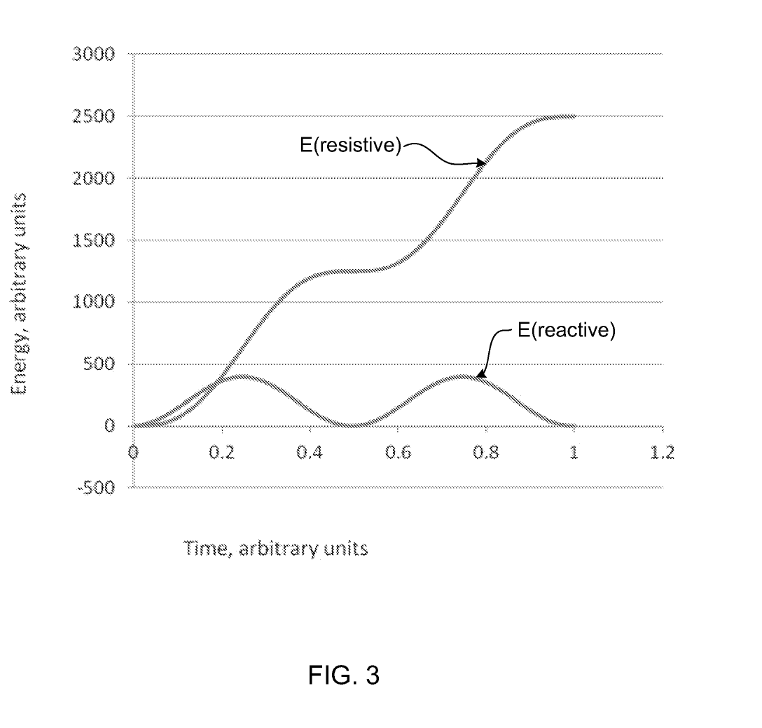

Thus, a reactive load can be both positive and negative. In fact, over a cycle, the total energy adds up to zero as can be seen by the energy input into both resistive and reactive loads. FIG. 3 shows impact of the energy on the reactive and resistive loads over one cycle. In particular, as shown in FIG. 3, the energy dissipated in a resistive load (E(resistive)) is substantially converted into heat, while the energy in the reactive load (E(reactive)) sloshes into and out of the load while no energy is dissipated, indicating no heat is generated in the reactive load.

Typically, power supply companies are concerned with subscribers connecting reactive loads to their generators because reactive loads use no energy and thus the power companies would derive no revenues from such loads. But this is not the case. In fact, there are two properties of the generator that can make a difference. The first is a significant resistance of the generator itself. When there is reactive current sloshing in and out of the load, that current flowing through the resistance of the power company wires and the generator dissipates heat. This dissipation is a loss of power for which the power company receives no revenue. As a result, if the reactive current gets too high, the power company will want its customers to reduce the reactive current with some sort of power factor correction. There is a second reason for the power companies to try avoiding inductive loads. It has to do with the way the generator is designed. The generator comprises a large coil of wire (the stator), wound around a core of magnetic material, usually some kind of iron or steel alloy. In the middle of that core of magnetic material is a rotating magnetic field, usually made with an iron or steel core with wires wrapped around it (the rotor). The current in the load flows through the stator so, in a large generator, the coil takes the shape of thick bars of low resistance material. Thus, the resistance of the stator can be very low. The current in the rotor is controlled to maintain a constant voltage on the output as the load varies.

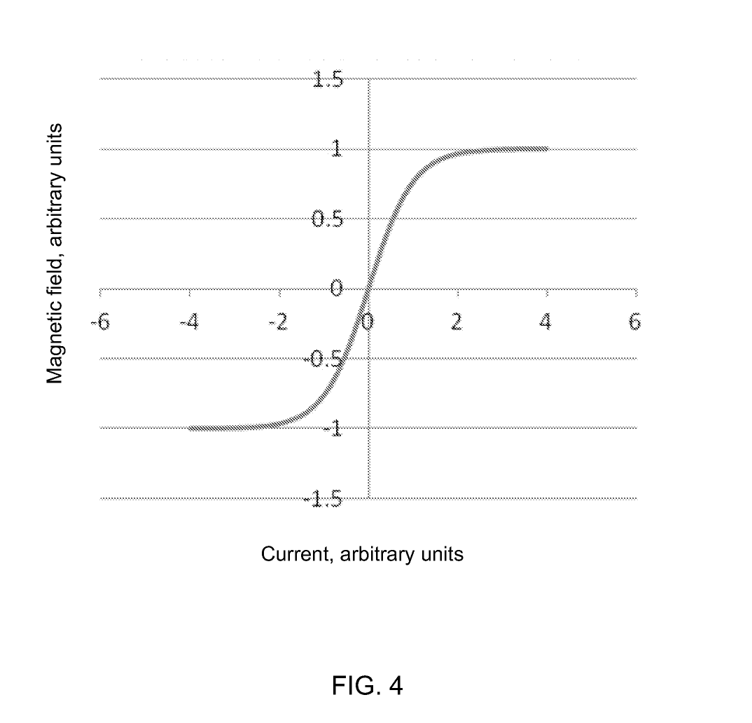

At low current, the magnetic field in the iron core is proportional to the current. In contrast, at higher current, the magnetic material saturates as indicated in FIG. 4, which shows magnetic field core saturation as a function of current. The maximum current output is an important design parameter and is typically matched, during the design phase, to the output voltage and the power source driving the generator. In addition, when the core saturates, there are generally losses in the core. If the generator were to drive only reactive loads, the core could be driven into saturation by the recirculating load current with significant consequences. Thus, it is important to keep the core from saturation.

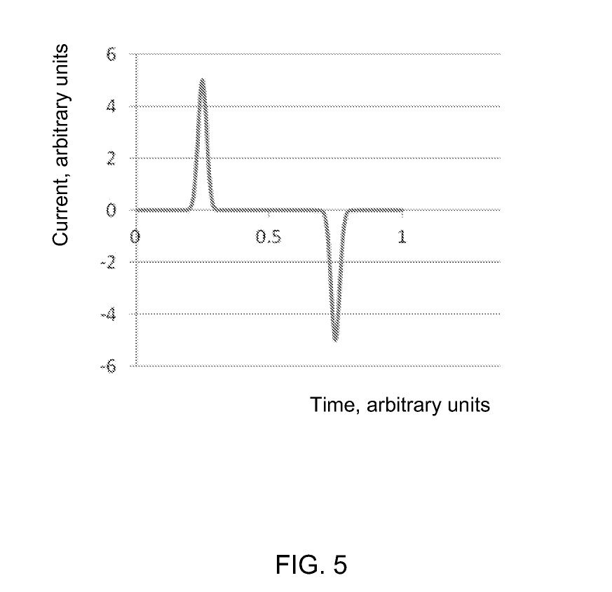

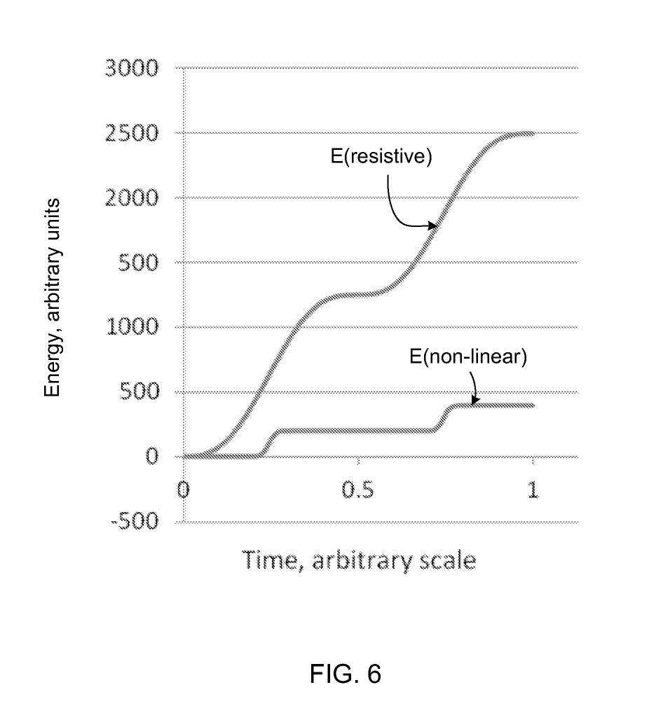

There is another type of load that causes problems with the generator. This load is non-linear, i.e., its current load can have unusual shapes such as periodical peaks as shown in the example in FIG. 5. It should be understood that the generator can deliver power only during the current spikes shown in FIG. 5, the rest of the time the generator is free-wheeling. Thus, the energy delivered to the load is greatly reduced because of this current load shape. FIG. 6 shows the energy delivered to a non-linear load over one cycle and energy delivered to a resistive load over the same cycle. Accordingly, if the whole load or a substantial part of the load connected to the generator includes a non-linear load, the current would saturate the core while the generator was generating only a fraction of its rated power. Therefore, to supply the rated power, a second generator would be required. This poorly conditioned power has significant impact on the installed generator capacity to deliver power. Generally, the power companies have no or limited control over the used loads, and thus overall efficiency might be affected.

The PFC may allow measuring similarities between a load and a resistor. As mentioned, there are two reasons for assessing a power factor. First, a reactive current can dissipate energy in the generator because the generator windings have a small, parasitic, resistance. To minimize this loss, the reactive current must be held low. The second reason is to increase the power output of a generator because a poorly conditioned power will impact the maximum output of the core due to core saturation issues.

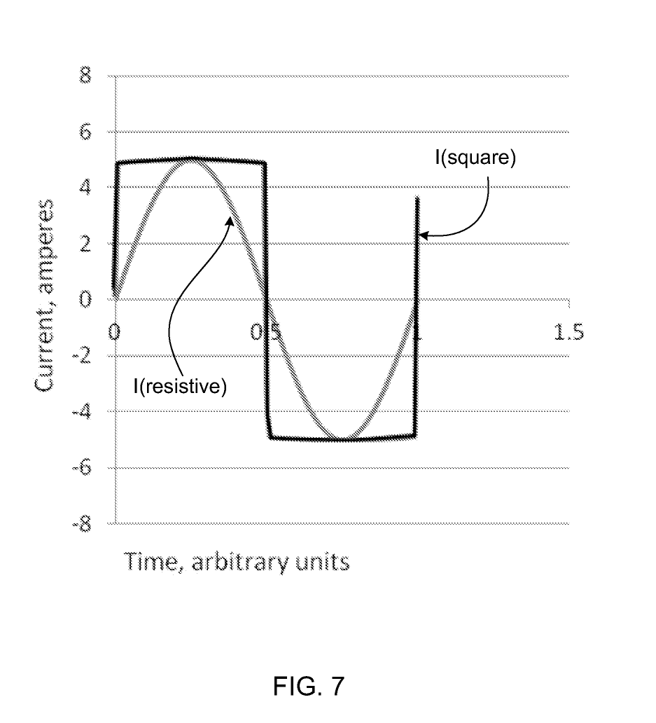

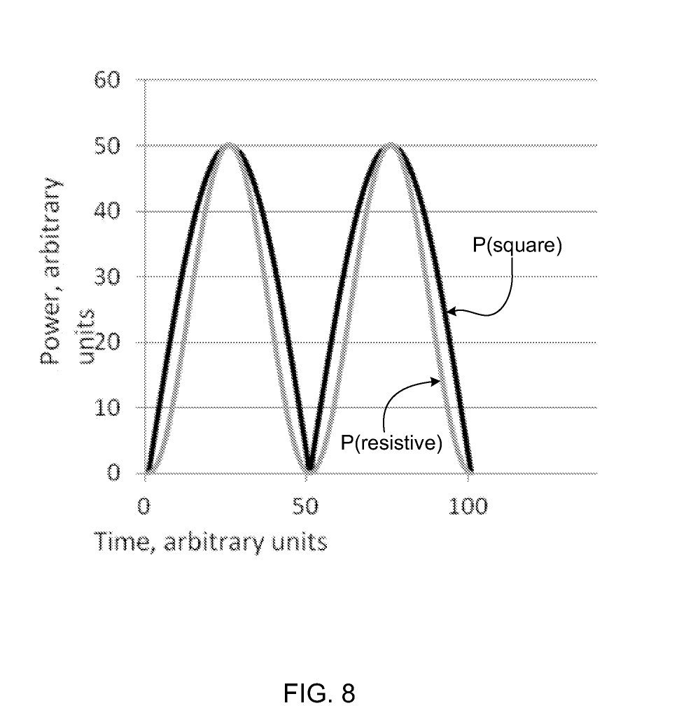

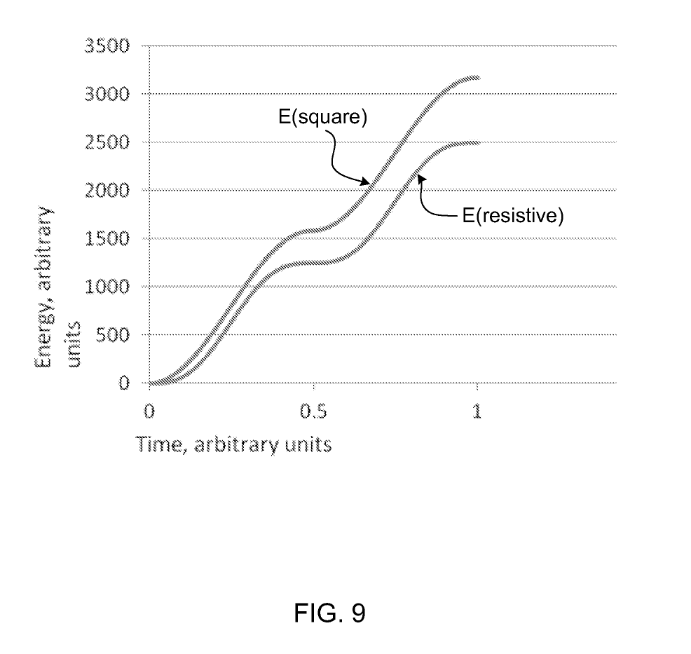

Assuming that a load exactly opposite the poorly conditioned load can be constructed (with very peaky currents discussed above) preferably with a square wave current shown in FIG. 7, more energy can be extracted from the generator without saturating the core. This approach allows increasing efficiency of power generators. Provided the load is designed to utilize the square wave current as shown in FIG. 7, the designed maximum current supplied by the generator can be extracted. This would allow more power to be generated on the skirts of the sine wave of the voltage. This is further illustrated by FIG. 8 which shows a resistive (resist) power curve compared to a power curve for a square wave current. Accordingly, this allows for a substantially greater amount of energy to flow into the load, as can be seen in the example waveforms in FIG. 9.

It should be noted that the greater amounts of energy may occur because of load shaping of the current wave form and not by modifying the generator. With the square wave current shape, the requirements can be met for core saturation. There will be more resistive losses in the generator because current flows at maximum level for nearly all the time.

The above principles are important for the embodiments of this disclosure providing an opportunity to make a load which has a more square shaped current characteristic as opposed to a pure sine wave which flows into a resistive load. The approach can be referred to as a super power factor correction (SPFC), which may reduce the number of generators required to supply peak loads.

Generally, the number of generators and the size of the generators are determined by peak loads. If the peak current is increased by 10%, for instance, there would be a large reduction in the installed base. In particular, this approach can be used with great advantage with generators driven by renewable power sources like wind, waves, hydrothermal, water, and so forth. When the conditions are right for producing peak power, generators can supply an added portion, which appears to be a nominal 10% increase above the designed value for the currently installed base. Otherwise, new generators can be sized appropriately to save materials and cost.

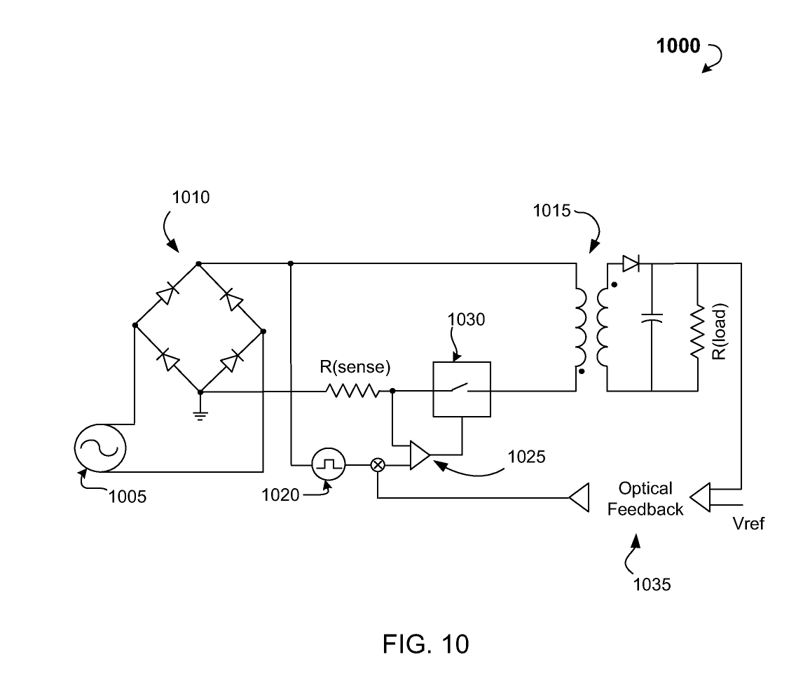

FIG. 10 shows a high level diagram of an exemplary AC-DC inverter 1000 enabled to perform SPFC. In this example, an AC power source 1005 is provided for AC-DC inverter 1000 which inverter includes a rectifier 1010, a coupled inductor (transformer) 1015, a current template circuit 1020, a PWM circuit 1025 associated with a sense resistor (Rsense), a switching circuit 1030, a closed feedback circuit 1035 (e.g., an optical feedback system shown), and a load resistance (Rload). The output of the AC-DC inverter 1000 can then be used either as a DC output or to generate an AC wave form to be utilized by any sort of load.

The current template circuit 1020 may provide a square wave template modulated by a feedback voltage provided by the closed feedback circuit 1035. The square wave template may control the switching circuit 1030, which in turn provides adjustment of the input power supply signal (e.g., the rectified power supply circuit) to be delivered to the load.

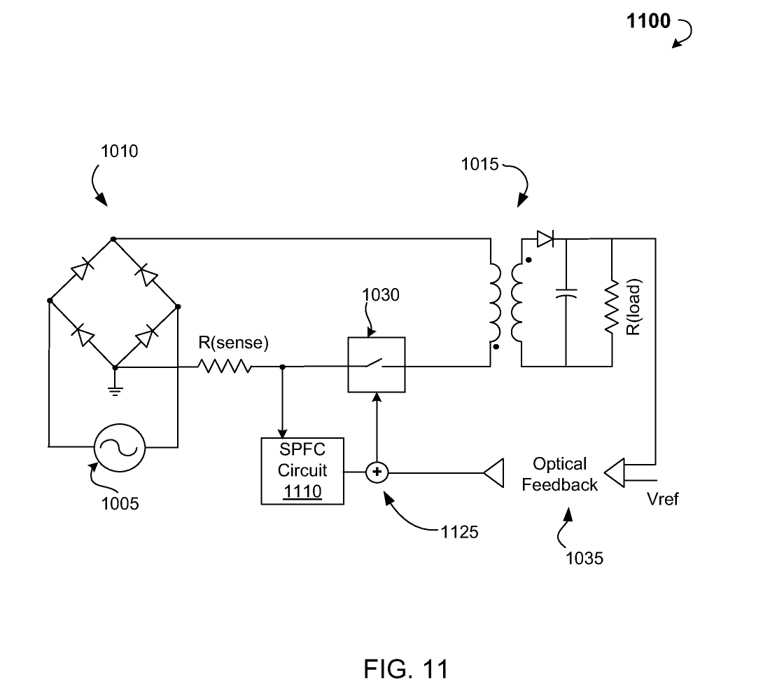

FIG. 11 shows another high level diagram of an exemplary AC-DC inverter 1100 enabling to perform SPFC (thus it is also referred to herein as SPFC circuit 1100). The inverter 1100 may receive an AC power source 1005 and may include a rectifier 1010, a coupled inductor 1015, a SPFC circuit 1110, a PWM circuit 1125, a sense resistor (Rsense), a switching circuit 1030, a closed feedback circuit 1035 (e.g., an optical feedback system), and a load resistance (Rload). Similarly, the output of the AC-DC inverter 1100 can be used either as a DC output or to generate an AC wave form to be utilized by any sort of load.

In various embodiments, the inductance of the coupled inductor 1015 must be small enough to reach high current with low input voltage in the time allotted for inductor charging. This means that the current loop must be fast enough at the peak of the voltage cycle to maintain a constant current. If the inductor is designed correctly, its saturation current will be that of the peak current out of the generator, since if the load of the generator were only the AC-DC inverter this would be the design constraint on the generator.

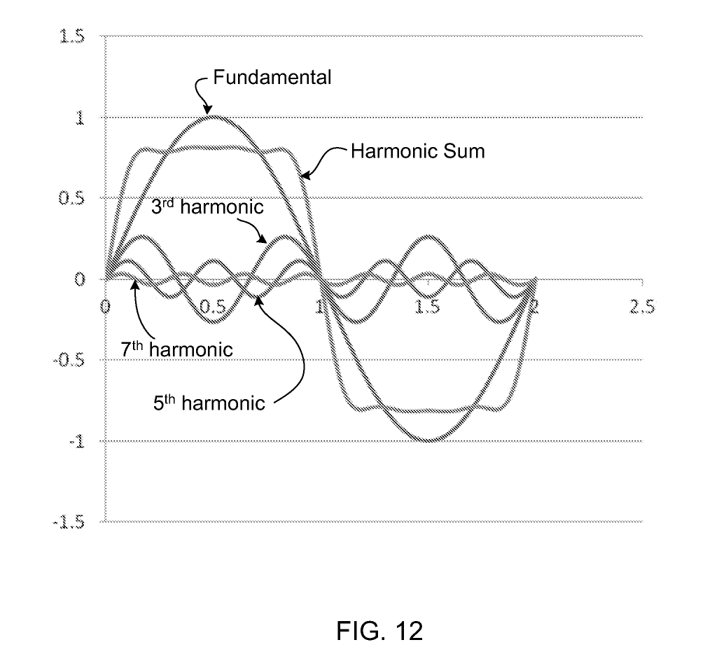

The SPFC circuit 1110 provides measuring a sense current signal on Rsense and analysis of its current wave. For example, a Fourier transform method or fast Fourier transform may be applied to extract from the sense current signal the amplitudes of any harmonic signals and a fundamental signal in the frequency domain. These amplitudes are then modified by the SPFC circuit 1110 by dividing by the fundamental signal, applying predetermined coefficients to each harmonic signal and then adding harmonic signals back from the frequency domain into the time domain. Optionally, the resulting combined signal can be multiplied by a gain factor to produce a duty factor distortion signal. This signal can be used in PWM circuit 1125 to control the duty factor. In other words, these circuits enable modulating of the PWM wave form to force the current wave form into a squarer waveform by adding harmonic signals. This principle is further illustrated in FIG. 12 which shows the fundamental signal and three odd harmonics, namely the 3^{rd}, 5^{th} and 7^{th} harmonics, in this example. When these three odd harmonics are added together, a harmonic sum signal (shown in FIG. 12) is produced. According to various embodiments, the harmonic sum signal is substantially of square shape.

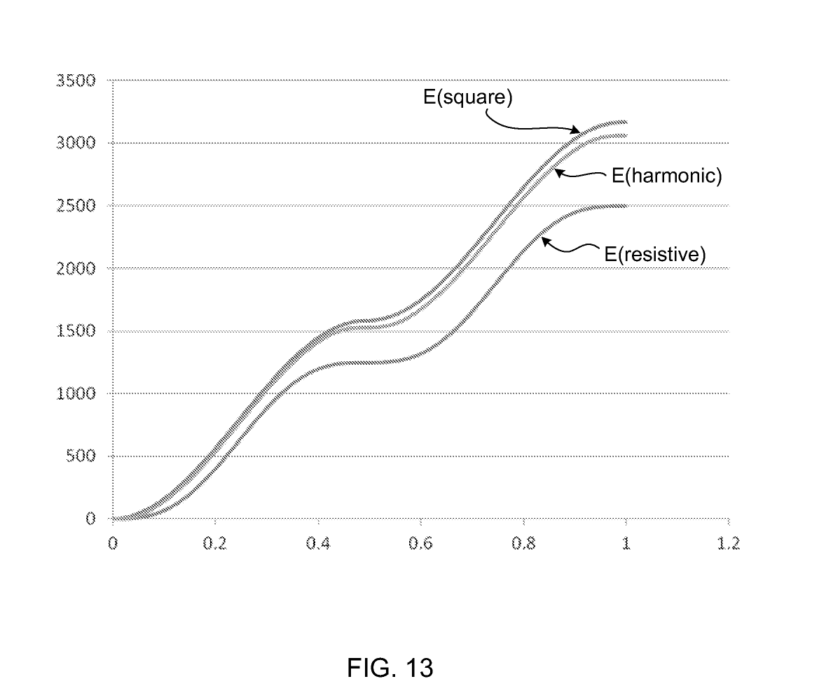

In some embodiments, the weights of each harmonic signal are Wfund=1, W3=¼, W5= 1/10, W7= 1/20. Accordingly, the peak current may be reduced by 16.4% to 0.836% of the peak of the fundamental signal when the disclosed technology is realized. If this were the current output of the generator and the fundamental signal were the maximum current output into a resistive load, by adding the harmonic signals, the peak current could be reduced. According to various embodiments, since the input voltage is a sine wave which is similar to the fundamental of the current wave form, the total power is the same delivered either with the fundamental wave or the sum of the fundamental and the harmonics except the peak current is reduced by 16.4%. If the peak current were restored to the generator design value of 1, then the generator can produce about 10% more energy in one cycle of the generator which corresponds to an increase of 22% more power when averaged over one cycle, as illustrated in the example waveforms depicted in FIG. 13.

Since the generator can operate at peak current, there is excess capacity available from the generator caused by the tailoring of the load current according to various embodiments. Thus, the generator can operate at 110% of designed capacity if this type of load is used exclusively. Since the number of generators is set by peak loads, this amounts to the reduction of installed capacity by 10%, according to various embodiments.

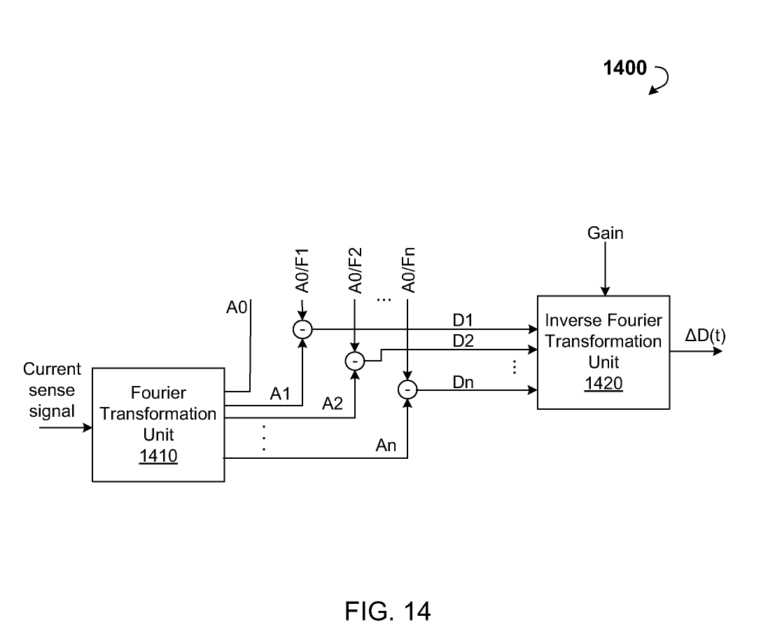

FIG. 14 shows a high level diagram of SPFC circuit 1400 according to an example embodiment. The SPFC circuit 1400 may be utilized in AC-DC inverters 1000, 1100. The SPFC circuit 1400 may include a Fourier transformation unit 1410 configured to perform Fourier transformation under the current sense signal to produce a fundamental signal A0 of the current sense signal and a plurality of harmonic signals (A1, A2, . . . An) associated with the current sense signal. The SPFC circuit 1400 may further includes a plurality of dividers to generate difference signals D1, D2, . . . Dn (e.g., harmonic signals excluding the fundamental signal), and an inverse Fourier transformation unit 1420 configured to produce a duty factor distortion signal (ΔD(t)) by combining the difference signals D1, D2, . . . Dn and applying a gain factor thereto.

Generally, to keep the current wave form as square as possible, the harmonics must be kept in precise ratio to the fundamental, according to various embodiments. The ratio numbers are denoted in the example in FIG. 14 by F1, F2 through Fn which present the proper amplitude to a difference block and compare the desired value to the actual value and produce a difference, D1, D2, through Dn. These differences may be passed through an inverse transform and multiplied by a gain factor before being used to force the control loop to have the correct values of the overtones by modulating the duty factor of the PWM signal. The loop gain may appear anywhere in the current sense and harmonic detect feedback loop.

In certain embodiments, the difference signals, D1, D2 through Dn, may be stored in a memory keyed to the state of the load and the input voltage and other parameters. Upon a change of state, new values can be quickly read from the memory associated with the new state if such values had previously been stored or calculated. Since the values of these differences can only be calculated, at most, each half cycle of AC line, this approach may speed up the establishment of an operating point. This same technique may be applied to the harmonic signals, A1, A2, through An. This presumed operating point may be used if more accurate values have not been measured.

The block diagrams shown in FIGS. 10, 11 reflect the usage with coupled inductors to show the usage as an isolated AC-DC inverter. In certain embodiments, the coupled inductor may be replaced with a simple inductor to produce a DC voltage which is not isolated from the AC power mains. In that instance, the output of the regulator may be either higher than the peak input voltage or lower than the peak input voltage. The former case would require a boost regulator topology having two switches, usually an active switch, and another switch which is usually a passive switch usually called a diode, in certain embodiments. If the output is lower than the peak input voltage, a boost-buck regulator topology is required with two active switches and two diodes are required in an H-bridge configuration, in certain embodiments. The buck-boost topology is the subject of pending U.S. patent application Ser. No. 13/216,195, which is incorporated herein in its entirety by reference.

In some embodiments, the generator may be connected directly to an AC-DC inverter which is the entire load of the generator. In this case, the AC-DC inverter can be matched to the generator with a super power factor correction to optimally load the generator for maximum power output for the smallest possible generator.

According to various embodiments, the super power factor correction will increase the resistive power losses in the generator because of the overall increase in the current. The higher harmonics in the current wave form may pose significant issues for the design of the generator or subsequent transformers. In certain embodiments, the generator may be dedicated to a particular load, like a server farm or an AC-DC-AC converter for transmission, and may be specifically designed with the super power factor correction load according to various embodiments,

In addition, it should be noted that the SPFC technology and corresponding circuit(s), according to various embodiments, may increase peak generator power capacity without much impact on the overall design of the generator. Particularly, in a wind powered generator, where the wind power is irregular, various embodiments can allow higher peak output when the wind is moving faster than the maximum designed wind velocity, thus increasing generator capacity.

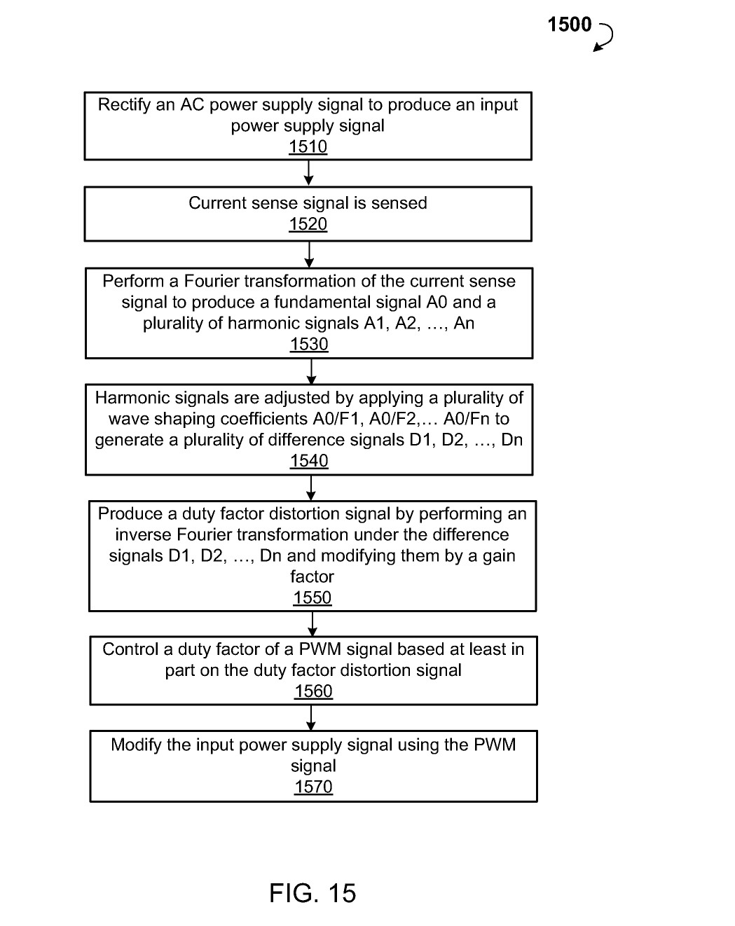

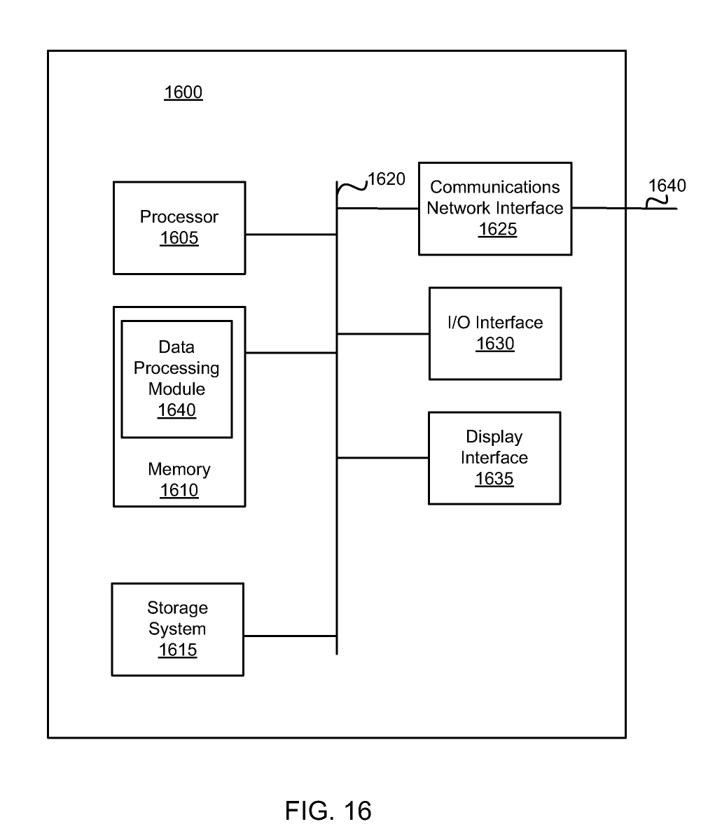

FIG. 15 shows a process flow diagram for a method 1500 for power factor correction according to an example embodiment. The method 1500 may be performed by processing logic that may comprise hardware (e.g., decision making logic, dedicated logic, programmable logic, and microcode), software (such as software run on a general-purpose computer system or a dedicated machine), or a combination of both. In one example embodiment, the method may be performed at least in part by the SPFC circuit 1400. In other words, the method 1500 can be performed by various components discussed above with reference to FIGS. 10, 11, 14, and optionally FIG. 16 (described further below).

The method 1500 may commence at operation 1510 with a rectifying circuit 1010 rectifying an AC power supply signal to produce an input power supply signal. Furthermore, at operation 1520, a current sense signal can be sensed at Rsense. It should be clear that the current sense signal is associated with the input power supply signal. At operation 1530, a Fourier transformation unit 1410 may perform a Fourier transformation (or fast Fourier transformation) of the current sense signal to produce a fundamental signal A0 of the current sense signal and a plurality of harmonic signals A1, A2, . . . , An, all associated with the current sense signal.

At operation 1540, each of the harmonic signals can be adjusted by applying a plurality of wave shaping coefficients A0/F1, A0/F2, . . . A0/Fn to generate a plurality of difference signals D1, D2, . . . , Dn. For example, the harmonic signals are adjusted by excluding the fundamental signal A0.

At operation 1550, the inverse Fourier transformation unit 1420 may produce a duty factor distortion signal by performing an inverse Fourier transformation under the difference signals D1, D2, . . . , Dn and modifying them by a gain factor.

At operation 1560, a duty factor of a PWM signal generated by the PWM circuit 1025 may be

controlled based at least in part on the duty factor distortion signal. In certain embodiments, the PWM signal is also dependent on a feedback signal provided by the closed feedback circuit 1035.

At operation 1570, the switching circuit 1030 may modify the input power supply signal using the PWM signal. The modified input power supply signal may then be directly or indirectly delivered to a load. In certain embodiments, the modified input power supply signal may be transformed into an AC output signal. Alternatively, it may be used as a DC output signal. Further, in certain embodiments, the method 1500 provides reduction of peaks of the input current signal waveform.

Referring now to FIG. 16, shown therein is a block diagram of exemplary system 1600 for practicing embodiments according to the present technology. The system 1600 may be used to implement a device suitable for power factor correction according to embodiments of the present technology. The system 1600 may include one or more processors 1605 and memory 1610. The memory 1610 may store, in part, instructions and data for execution by the processor 1605. The memory 1610 may store executable code when in operation. The memory 1610 may include a data processing module 1640 for processing data. The system 1600 may further include a storage system 1615, communication network interface 1625, input and output (I/O) interface(s) 1630, and display interface 1635.

The components shown in FIG. 16 are depicted as being communicatively coupled via a bus 1620. The components may be communicatively coupled via one or more data transport means. The processor 1605 and memory 1610 may be communicatively coupled via a local microprocessor bus, and the storage system 1615 and display interface 1635 may be communicatively coupled via one or more input/output (I/O) buses. The communications network interface 1625 may communicate with other digital devices (not shown) via a communications medium.

The storage system 1615 may include a mass storage device and portable storage medium drive(s). The mass storage device may be implemented with a magnetic disk drive or an optical disk drive, which may be a non-volatile storage device for storing data and instructions for use by the processor 1605. The mass storage device can store system software for implementing embodiments according to the present technology for purposes of loading that software into the memory 1610. Some examples of the memory 1610 may include RAM and ROM.

A portable storage device, as part of the storage system 1615, may operate in conjunction with a portable non-volatile storage medium, such as a floppy disk, compact disk or digital video disc (DVD), to input and output data and code to and from the system 1600 of FIG. 16. System software for implementing embodiments of the present invention may be stored on such a portable medium and input to the system 1600 via the portable storage device.

The memory and storage system of the system 1600 may include a non-transitory computer-readable storage medium having stored thereon instructions executable by a processor to perform methods according to various embodiments of the present technology. The instructions may include software used to implement modules discussed herein, and other modules.

I/O interfaces 1630 may provide a portion of a user interface, receive audio input (via a microphone), and provide audio output (via a speaker). The I/O interfaces 1630 may include an alpha-numeric keypad, such as a keyboard, for inputting alpha-numeric and other information, or a pointing device, such as a mouse, trackball, stylus, or cursor direction keys.

The display interface 1635 may include a liquid crystal display (LCD) or other suitable display device. The display interface 1635 may receive textual and graphical information, and process the information for output to the display interface 1635.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the present technology. Those skilled in the art are familiar with instructions, processor(s), and storage media.

It is noteworthy that any hardware platform suitable for performing the processing described herein is suitable for use with the invention. The terms “non-transitory computer-readable storage medium” and “non-transitory computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, DVD, any other optical medium, any other physical medium with patterns of marks or holes, a RAM, a PROM, an EPROM, an EEPROM, a flash EEPROM, a non-flash EEPROM, any other memory chip or cartridge, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

An exemplary computing system may be used to implement various embodiments of the systems and methods disclosed herein. The computing system may include one or more processors and memory. The memory may include a computer-readable storage medium. Common forms of computer-readable storage media include, for example, a floppy disk, a flexible disk, a hard disk, magnetic tape, any other magnetic medium, a CD-ROM disk, DVD, various forms of volatile memory, non-volatile memory that can be electrically erased and rewritten. Examples of such non-volatile memory include NAND flash and NOR flash and any other optical medium, the memory is described in the context of. The memory can also comprise various other memory technologies as they become available in the future.

Main memory stores, in part, instructions and data for execution by a processor to cause the computing system to control the operation of the various elements in the systems described herein to provide the functionality of certain embodiments. Main memory may include a number of memories including a main random access memory (RAM) for storage of instructions and data during program execution and a read only memory (ROM) in which fixed instructions are stored. Main memory may store executable code when in operation. The system further may include a mass storage device, portable storage medium drive(s), output devices, user input devices, a graphics display, and peripheral devices. The components may be connected via a single bus. Alternatively, the components may be connected via multiple buses. The components may be connected through one or more data transport means. Processor unit and main memory may be connected via a local microprocessor bus, and the mass storage device, peripheral device(s), portable storage device, and display system may be connected via one or more input/output (I/O) buses.

Mass storage device, which may be implemented with a magnetic disk drive or an optical disk drive, may be a non-volatile storage device for storing data and instructions for use by the processor unit. Mass storage device may store the system software for implementing various embodiments of the disclosed systems and methods for purposes of loading that software into the main memory. Portable storage devices may operate in conjunction with a portable non-volatile storage medium, such as a floppy disk, compact disk or DVD, to input and output data and code to and from the computing system. The system software for implementing various embodiments of the systems and methods disclosed herein may be stored on such a portable medium and input to the computing system via the portable storage device.

Input devices may provide a portion of a user interface. Input devices may include an alpha-numeric keypad, such as a keyboard, for inputting alpha-numeric and other information, or a pointing device, such as a mouse, a trackball, stylus, or cursor direction keys. In general, the term input device is intended to include all possible types of devices and ways to input information into the computing system. Additionally, the system may include output devices. Suitable output devices include speakers, printers, network interfaces, and monitors. Display system may include a liquid crystal display (LCD) or other suitable display device. Display system may receive textual and graphical information, and processes the information for output to the display device. In general, use of the term output device is intended to include all possible types of devices and ways to output information from the computing system to the user or to another machine or computing system.

Peripherals may include any type of computer support device to add additional functionality to the computing system. Peripheral device(s) may include a modem or a router or other type of component to provide an interface to a communication network. The communication network may comprise many interconnected computing systems and communication links. The communication links may be wireless links, optical links, wireless links, or any other mechanisms for communication of information. The components contained in the computing system may be those typically found in computing systems that may be suitable for use with embodiments of the systems and methods disclosed herein and are intended to represent a broad category of such computing components that are well known in the art. Thus, the computing system may be a personal computer, hand held computing device, telephone, mobile computing device, workstation, server, minicomputer, mainframe computer, or any other computing device. The computer may also include different bus configurations, networked platforms, multi-processor platforms, etc.

Various operating systems may be used including Unix, Linux, Windows, Macintosh OS, Palm OS, and other suitable operating systems. Due to the ever changing nature of computers and networks, the description of the computing system is intended only as a specific example for purposes of describing embodiments. Many other configurations of the computing system are possible having more or fewer components.

It is noteworthy that various modules and engines may be located in different places in various embodiments. Modules and engines mentioned herein can be stored as software, firmware, hardware, as a combination, or in various other ways. It is contemplated that various modules and engines can be removed or included in other suitable locations besides those locations specifically disclosed herein. In various embodiments, additional modules and engines can be included in the exemplary embodiments described herein.

The foregoing detailed description of the technology herein has been presented for purposes of illustration and description. It is not intended to be exhaustive or to limit the technology to the precise form disclosed. Many modifications and variations are possible in light of the above teaching. For example, software modules and engines discussed herein may be combined, expanded into multiple modules and engines, communicate with any other software module(s) and engine(s), and otherwise may be implemented in other configurations. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for performing power factor correction on an input power supply signal, the method comprising:
performing, by a Fourier transformation unit, a Fourier transformation of a current sense signal associated with the input power supply signal to produce a fundamental signal of the current sense signal and a plurality of harmonic signals associated with the current sense signal;
adjusting each of the harmonic signals based at least in part on a plurality of wave shaping coefficients to generate a plurality of difference signals;
producing, by an inverse Fourier transformation unit, a duty factor distortion signal based at least in part on all of the difference signals;
controlling a duty factor of a pulse width modulation (PWM) signal based at least in part on the duty factor distortion signal; and
modifying the input power supply signal using at least the PWM signal.

2. The method of claim 1, wherein the plurality of wave shaping coefficients is based on the fundamental signal and multiple harmonic ratio values.

3. The method of claim 2, wherein each of the wave shaping coefficients includes the fundamental signal multiplied by a harmonic ratio value, wherein each of the wave shaping coefficients is associated with a corresponding harmonic ratio value.

4. The method of claim 2, wherein the adjusting of each of the harmonic signals includes extracting the wave shaping coefficients from each of the harmonic signals.

5. The method of claim 1, wherein the producing of the duty factor distortion signal includes performing inverse Fourier transformation under the plurality of difference signals and multiplying a signal resulted from the inverse Fourier transformation onto a gain signal.

6. The method of claim 1, wherein the PWM signal is based on the duty factor distortion signal and a current feedback signal.

7. The method of claim 1, further comprising rectifying an alternative current (AC) power supply signal to produce the input power supply signal.

8. The method of claim 1, further comprising transforming the input power supply signal into an output power supply signal.

9. The method of claim 8, wherein the output power supply signal includes an AC output signal.

10. The method of claim 8, wherein the output power supply signal includes a direct current (DC) output signal.

11. The method of claim 1, further comprising storing the plurality of difference signals in a memory in association with a current state of a load.

12. The method of claim 1, wherein the modifying of the input power supply signal using at least the PWM signal includes producing a substantially square signal.

13. The method of claim 1, further comprising using a closed loop scheme to produce a current feedback signal.

14. The method of claim 1, further comprising reducing peaks of the input power supply signal.

15. The method of claim 1, further comprising measuring the current sense signal of the input power supply signal.

16. A circuit for performing power factor correction on an input power supply signal, the circuit comprising:
a sensing unit configured to produce a current sense signal associated with the input power supply signal;
a Fourier transformation unit configured to perform Fourier transformation under the current sense signal to produce a fundamental signal of the current sense signal and a plurality of harmonic signals associated with the current sense signal;
a power factor correction unit configured to adjust each of the harmonic signals based at least in part on predetermined criteria;
an inverse Fourier transformation unit configured to produce a duty factor distortion signal based at least in part on the adjusted harmonic signals; and
a PWM unit configured to control a duty factor of a PWM signal based at least in part on the duty factor distortion signal and to modify the input power supply signal using at least the PWM signal.

17. The circuit of claim 16, wherein the power factor correction unit is further configured to produce plurality of difference signals by adjusting each of the harmonic signals.

18. The circuit of claim 17, wherein the adjusting of each of the harmonic signals includes extracting wave shaping coefficients from the harmonic signals, wherein each of the wave shaping coefficients includes the fundamental signal multiplied by a harmonic ratio value, and wherein each of the wave shaping coefficients is associated with a corresponding harmonic ratio value.

19. The circuit of claim 16, further comprising a rectifying circuit configured to rectify an AC power supply signal to produce the input power supply signal.

20. A method for performing power factor correction on an input power supply signal, the method comprising:
rectifying an AC power supply signal to produce the input power supply signal;
sensing a current sense signal associated with the input power supply signal;
retrieving a plurality of harmonic signals of the current sense signal;
producing a plurality of adjusted harmonic signals based at least in part on predetermined criteria;
generating a duty factor distortion signal based at least in part on a combination of the plurality of adjusted harmonic signals;
controlling a duty factor of a PWM signal based at least in part on the duty factor distortion signal to generate a substantially square wave of the PWM signal; and
modifying the input power supply signal using at least the PWM signal.
